(19) United States
(12) Patent Application Publication
(10) Pub. No.: US 2026/0071966 A1
(43) Pub. Date: Mar. 12, 2026

(54) ELECTRIC FIELD ENHANCEMENT DEVICE AND RAMAN SPECTROSCOPIC APPARATUS

(71) Applicant: SEIKO EPSON CORPORATION, Tokyo (JP)

(72) Inventors: Fumika YAMADA, SHIOJIRI-SHI (JP); Yoshitaka ITO, MATSUMOTO-SHI (JP); Kaho TAKEUCHI, MATSUMOTO-SHI (JP)

(73) Assignee: SEIKO EPSON CORPORATION, Tokyo (JP)

(21) Appl. No.: 19/318,386

(22) Filed: Sep. 4, 2025

(30) Foreign Application Priority Data
Sep. 6, 2024 (JP) 2024-154125

(51) Int. Cl. G01N 21/65

(52) U.S. Cl. CPC G01N 21/658

(57) ABSTRACT

An electric field enhancement device includes a substrate, a plurality of microstructures provided to the substrate and having electrical conductivity, and a transparent layer configured to cover the plurality of microstructures and the substrate, wherein the transparent layer has a concavo-convex structure on a surface at an opposite side to the microstructures, and an enhanced electric field generated by the plurality of microstructures is maximized at a position at an opposite side of the microstructures to the substrate in a normal direction to the substrate and separated from the plurality of microstructures.

The present application is based on, and claims priority from JP Application Serial Number 2024-154125, filed Sep. 6, 2024, the disclosure of which is hereby incorporated by reference herein in its entirety.

### BACKGROUND

### 1. Technical Field

The present disclosure relates to an electric field enhancement device and a Raman spectroscopic apparatus.

### 2. Related Art

A Raman spectroscopic apparatus using localized surface plasmon resonance (LSPR) is known as one of spectroscopic techniques for detecting low-concentration sample molecules. In such a Raman spectroscopic apparatus, an enhanced electric field is formed by an electric field enhancement device having a nanometer-scale microstructure to generate surface enhanced Raman scattering (SERS) in which Raman scattered light is enhanced.

For example, JP-A-2013-096939 discloses an optical device including a substrate, a metal microstructure which is configured with a plurality of metal particles and is formed on a surface of the substrate, and an organic molecular film formed on the metal microstructure.

JP-A-2013-096939 is an example of the related art.

In such an optical device as described above, a further improvement in detection sensitivity is required.

### SUMMARY

An electric field enhancement device according to an application example of the present disclosure includes:
a substrate;
a plurality of microstructures provided to the substrate and having electrical conductivity; and
a transparent layer configured to cover the plurality of microstructures and the substrate, wherein
the transparent layer has a concavo-convex structure on a surface at an opposite side to the microstructures, and
an enhanced electric field generated by the plurality of microstructures is maximized at a position at an opposite side of the microstructures to the substrate in a normal direction to the substrate and separated from the plurality of microstructures.

A Raman spectroscopic apparatus according to an application example of the present disclosure includes:
the electric field enhancement device according to the application example of the present disclosure;
a light source configured to irradiate the electric field enhancement device with light; and
a detector configured to detect light from the electric field enhancement device.

### BRIEF DESCRIPTION OF THE DRAWINGS

FIG. 1 is a cross-sectional view schematically showing an electric field enhancement device according to an embodiment.

FIG. 2 is a plan view schematically showing the electric field enhancement device according to the embodiment.

FIG. 3 is a plan view schematically showing the electric field enhancement device according to the embodiment.

FIG. 4 is a plan view schematically showing the electric field enhancement device according to the embodiment.

FIG. 5 is a plan view schematically showing the electric field enhancement device according to the embodiment.

FIG. 6 is a plan view schematically showing the electric field enhancement device according to the embodiment.

FIG. 7 is a conceptual diagram illustrating the plasmon resonance in the electric field enhancement device.

FIG. 8 is a conceptual diagram illustrating the plasmon resonance in the electric field enhancement device.

FIG. 9 is a diagram illustrating an enhanced electric field generated by the microstructure of the electric field enhancement device.

FIG. 10 is a top view schematically showing an electric field enhancement device according to the embodiment.

FIG. 11 is a cross-sectional view schematically showing the electric field enhancement device according to the embodiment.

FIG. 12 is a cross-sectional view schematically showing the electric field enhancement device according to the embodiment.

FIG. 13 is a cross-sectional view schematically showing the electric field enhancement device according to the embodiment.

FIG. 14 is a cross-sectional view schematically showing an electric field enhancement device according to a first modified example of the embodiment.

FIG. 15 is a cross-sectional view schematically showing an electric field enhancement device according to a second modified example of the embodiment.

FIG. 16 is a diagram schematically showing a Raman spectroscopic apparatus according to the embodiment.

FIG. 17 is a diagram illustrating the principle of Raman scattering spectroscopy.

FIG. 18 is a schematic diagram showing an example of a Raman spectrum acquired by the Raman scattering spectroscopy.

FIG. 19 is an X-Z cross-sectional view schematically showing a repeating unit of a model used in a simulation.

FIG. 20 is an X-Y cross-sectional view schematically showing the model used in the simulation.

FIG. 21 is a table showing a comparison of principal parameters in Practical Example 1, Reference Example 1, and Comparative Example 1.

FIG. 22 is a diagram showing a simulation result of Practical Example 1 in Experimental Example A.

FIG. 23 is a diagram showing a simulation result of Reference Example 1 in Experimental Example A.

FIG. 24 is a diagram showing a simulation result of Comparative Example 1 in Experimental Example A.

FIG. 25 is a diagram showing a simulation result of Practical Example 1 in Experimental Example B.

FIG. 26 is a diagram showing a simulation result of Practical Example 2 in Experimental Example B.

FIG. 27 is a diagram showing a simulation result of Practical Example 3 in Experimental Example B.

FIG. 28 is a diagram showing a simulation result of Reference Example 2 in Experimental Example B.

### DESCRIPTION OF EMBODIMENTS

An electric field enhancement device and a Raman spectroscopic apparatus of the present disclosure will hereinafter be described in detail based on an embodiment shown in the accompanying drawings.

### 1. Electric Field Enhancement Device

First, an electric field enhancement device according to the embodiment will be described.

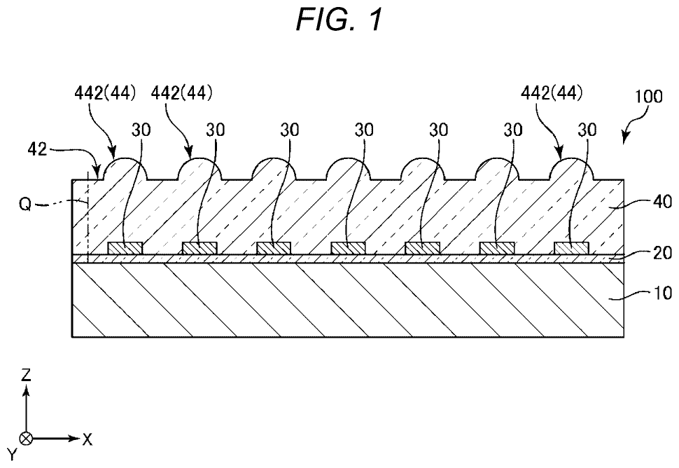

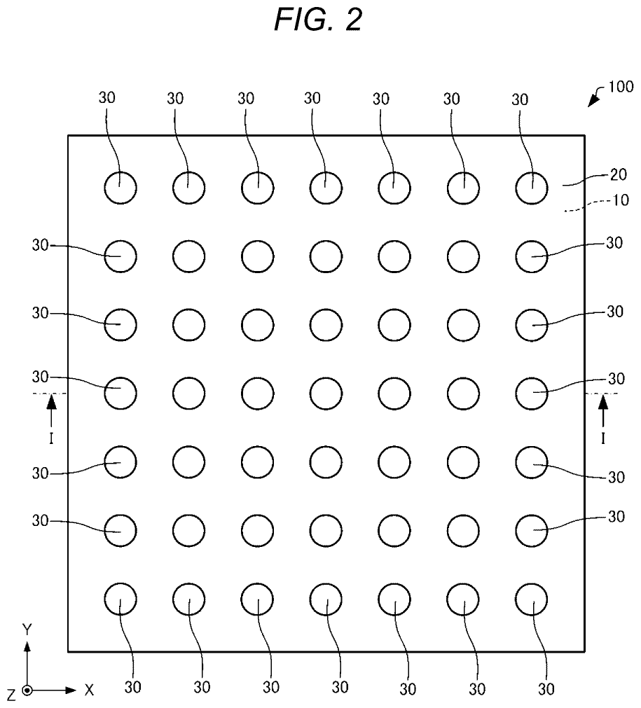

FIG. 1 is a cross-sectional view schematically showing an electric field enhancement device 100 according to the embodiment. FIGS. 2 to 6 are each a plan view schematically showing microstructures 30 of the electric field enhancement device 100 according to the embodiment. Note that FIG. 1 is a cross-sectional view along the line I-I in FIG. 2. Further, in each of the drawings of the present application, an X axis, a Y axis, and a Z axis are set as three axes orthogonal to each another, and are respectively indicated by arrows. Further, a tip side of the arrow of each axis is referred to as a “plus side”, and a base end side thereof is referred to as a “minus side”. Further, the Z axis plus side is also referred to as “upside”, and the Z axis minus side is also referred to as “downside”.

### 1.1. Configuration

The electric field enhancement device 100 shown in FIGS. 1 and 2 includes a substrate 10, a dielectric layer 20, microstructures 30, and a transparent layer 40. Note that in FIGS. 2 to 6, the transparent layer 40 is not shown.

The substrate 10 supports a plurality of microstructures 30 via the dielectric layer 20. When light from a light source used for Raman scattering is incident from the substrate 10 side in FIG. 1, the incident light is transmitted through the substrate 10 and the dielectric layer 20 and reaches the microstructures 30. When light is incident from the transparent layer 40 side in FIG. 1, the incident light is transmitted through the transparent layer 40 and reaches the microstructures 30. Note that in this case, it may be arranged that the incident light is reflected by the substrate 10 toward the transparent layer 40.

When the incident light reaches the plurality of microstructures 30, an enhanced electric field is generated. The enhanced electric field is maximized at a position above the microstructure 30, that is, at a position at an opposite side of the microstructure 30 to the substrate 10 in a normal direction to the substrate 10 and separated from the plurality of microstructures 30.

Further, an upper surface 42 of the transparent layer 40 (the surface at an opposite side to the microstructures 30) has a concavo-convex structure 44. The concavo-convex structure 44 weakens the gradient of the refractive index on the upper surface 42 to reduce the probability that light is confined inside the transparent layer 40. Accordingly, the enhanced electric field at a position above the upper surface 42 can further be strengthened.

According to such a configuration, the detection signal caused by the target substance disposed on the transparent layer 40 can be enhanced. Accordingly, the electric field enhancement device 100 in which an improvement in the detection sensitivity of the target substance is achieved can be obtained.

Examples of the substrate 10 include a glass substrate and a silicon substrate. Examples of the material of the glass substrate include SiO₂ (quartz glass). Examples of the material of the silicon substrate include single crystal silicon, polycrystalline silicon, and amorphous silicon.

In FIG. 1, a normal line to the upper surface of the substrate 10 is represented by Q. In FIG. 1, a normal line Q is set to be parallel to the Z axis.

The dielectric layer 20 shown in FIG. 1 is disposed between the substrate 10 and the microstructures 30. The thickness of the dielectric layer 20 is not particularly limited, but is preferably no less than 1 nm and no more than 2000 nm, and more preferably no less than 10 nm and no more than 1000 nm. Note that the dielectric layer 20 may be omitted.

The thickness of the dielectric layer 20 is measured from an observation image obtained by observing a cross-section of the dielectric layer 20 with an electron microscope. In the observation image, the length in the Z-axis direction of the dielectric layer 20 is measured at 10 or more points extracted randomly, and an average value thereof is defined as the “thickness”.

The dielectric layer 20 is transparent with respect to the light from the light source. Examples of the material of the dielectric layer 20 include Al₂O₃, TiOz, MgO, LiNbO₃, HfO₂, Ta₂O₅, SiON, Si₃NA, SiOx (0<x<3), PMMA (acrylic resin), PVA (polyvinyl alcohol), and polysilazane. The dielectric layer 20 may be formed of a plurality of layers. In this case, the materials of the plurality of layers may be the same as each other, or may be different from each other.

The microstructures 30 shown in FIG. 1 are disposed between the dielectric layer 20 and the transparent layer 40. The microstructure 30 has, for example, a cylindrical shape. The diameter of the microstructure 30 is not particularly limited, but is preferably no less than 1 nm and no more than 1000 nm, more preferably no less than 5 nm and no more than 500 nm, and still more preferably no less than 10 nm and no more than 400 nm.

Note that when the planar shape (the shape when viewed on the Z axis) of the microstructure 30 is a circle, the “diameter of the microstructure 30” is a diameter of the circle, and when the planar shape of the microstructure 30 is not a circle, the “diameter of the microstructure 30” is a diameter of a minimum inclusion circle. As an example of the latter, when the planar shape of the microstructure 30 is a polygon, a minimum circle including the polygon inside is the “minimum inclusion circle”. Further, when the planar shape of the microstructure 30 is an ellipse, a minimum circle including the ellipse inside is the “minimum inclusion circle”.

The thickness of the microstructures 30 is not particularly limited, but is preferably no less than 1 nm and no more than 500 nm, more preferably no less than 5 nm and no more than 300 nm, and still more preferably no less than 30 nm and no more than 200 nm. Accordingly, the enhanced electric field can further be strengthened.

The plurality of microstructures 30 is disposed. The plurality of microstructures 30 is separated from each other. The transparent layer 40 is disposed between the microstructures 30 adjacent to each other. A distance between the microstructures 30 adjacent to each other is not particularly limited, but is preferably no less than 20 nm and no more than 1000 nm, and more preferably no less than 100 nm and no more than 900 nm.

The plurality of microstructures 30 is arranged at a predetermined pitch in a predetermined direction when viewed from the Z-axis direction. That is, the microstructures 30 are periodically disposed. In the example shown in FIG. 2, the plurality of microstructures 30 is arranged in a square lattice shape.

According to such a configuration, in the electric field enhancement device 100, it is possible to reduce a variation in the intensity of the enhanced electric field in an in-plane direction of the substrate 10. When the plurality of microstructures is randomly arranged, only the microstructures having a diameter matching the wavelength of the light from the light source induce the LSPR. Therefore, there is a possibility that the intensity of the enhanced electric field varies in the in-plane direction. In contrast, since the microstructures 30 are periodically disposed, it is possible to induce surface lattice resonance (SLR) described later.

Note that the “pitch of the microstructures 30” is a distance between the centers of the microstructures 30 adjacent to each other in a predetermined direction. When the planar shape of the microstructure 30 is a circle, the “center of the microstructure 30” is the center of the circle, and when the planar shape of the microstructure 30 is not a circle, the “center of the microstructure 30” is the center of the minimum inclusion circle.

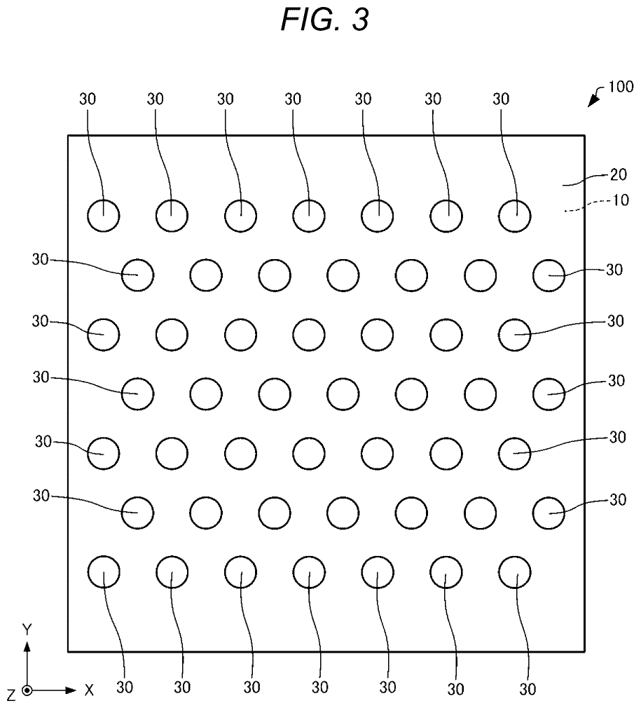

Further, when viewed from the Z-axis direction, the plurality of microstructures 30 may be disposed in a triangular lattice shape as illustrated in FIG. 3. Further, although not illustrated, the periodicity of the plurality of microstructures 30 may expand or contract at a certain ratio, and the plurality of microstructures 30 may include a fractal structure.

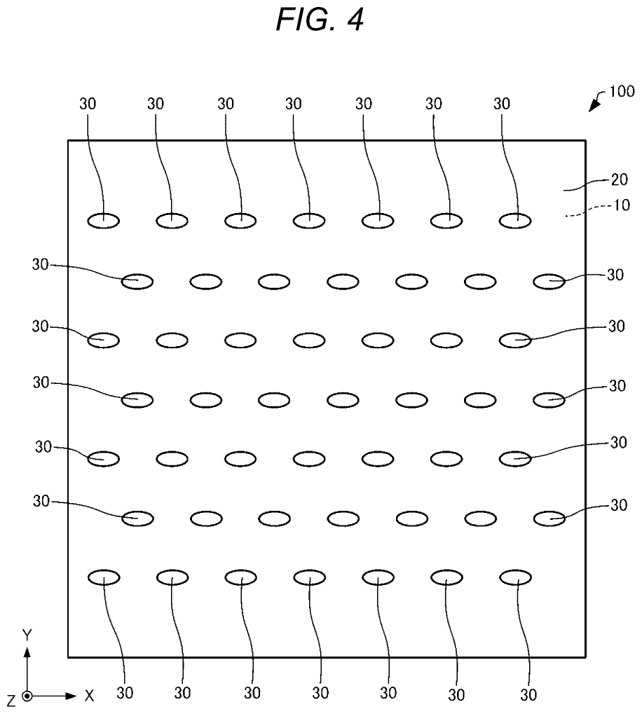

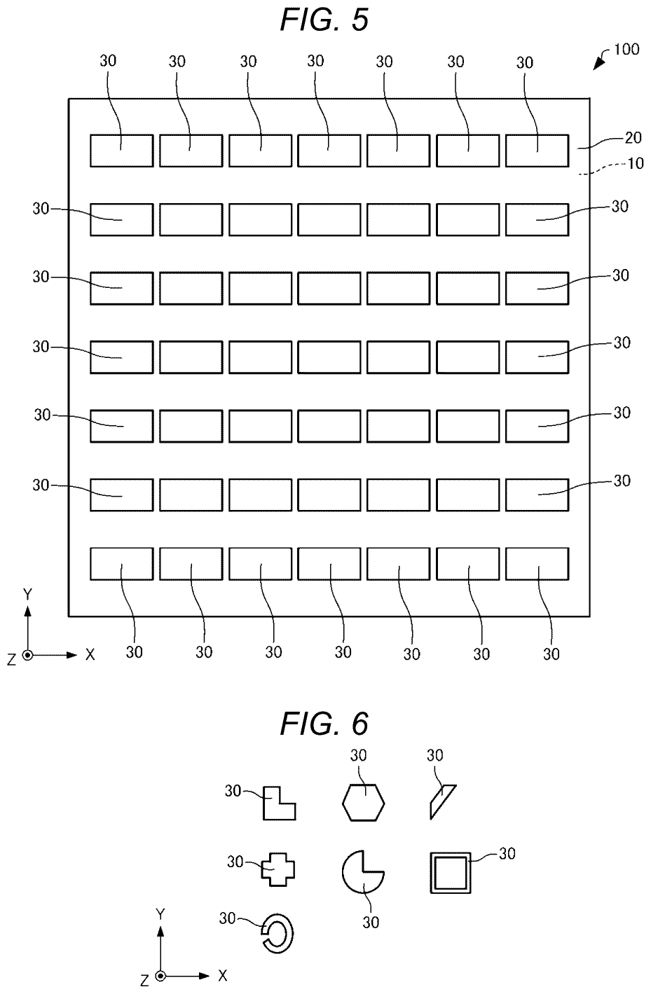

The planar shape of the microstructure 30 is not limited to a circular shape. For example, the planar shape of the microstructure 30 may be an elliptical shape as illustrated in FIG. 4, may be a rectangular shape as illustrated in FIG. 5, or may be a shape such as a particle shape, a polygonal shape, an annular shape, or a linear shape as illustrated in FIG. 6. Further, the plurality of microstructures 30 may be a combination of those different in shape from each other. Accordingly, it is possible to control the intensity and distribution of the enhanced electric field generated by the plurality of microstructures 30 in the in-plane direction orthogonal to the normal line Q.

In addition, the cross-sectional shape of the microstructures 30 is not particularly limited, and may be a trapezoid, a semicircle, a circle, a reverse tapered shape, a tip spherical shape, or the like. Further, the shapes of the microstructures 30 may each be a truncated quadrangular pyramid or a cone.

Further, although not illustrated, a plurality of recesses may be provided to the upper surface of the dielectric layer 20, and the microstructures 30 may be disposed in the recesses.

The microstructures 30 have electrical conductivity. Examples of the material of the microstructures 30 include simple substances or alloys of metals such as Al, Au, Ag, Cu, Pt, Pd, and Ni. Since such a metal has particularly good electrical conductivity, the enhanced electric field can be further strengthened. Further, the microstructures 30 may be metal particles. Note that the material of the microstructures 30 is not particularly limited as long as the material has a plasma frequency with respect to the light from the light source, and may be a transparent electrode material such as indium tin oxide (ITO), a carbon-based material such as carbon nanotubes, or the like.

The transparent layer 40 is disposed on the microstructures 30 and the dielectric layer 20. That is, the transparent layer 40 is disposed to cover the plurality of microstructures 30 and the substrate 10. The thickness of the transparent layer 40 is not particularly limited, but is preferably no less than 10 nm and no more than 2000 nm, and more preferably no less than 20 nm and no more than 1000 nm.

The thickness of the transparent layer 40 is measured from an observation image obtained by observing a cross-sectional surface of the transparent layer 40 with an electron microscope. In the observation image, the length in the Z-axis direction of the transparent layer 40 is measured at 10 or more points randomly extracted, and an average value thereof is defined as the “thickness”.

The transparent layer 40 is transparent with respect to the light from the light source. Examples of the material of the transparent layer 40 include various dielectric materials such as Al₂O₃, TiOz, MgO, LiNbO₃, HfO₂, Ta₂O₅, SiON, Si₃N₄, and SiOx (0<x<3). Further, SiOx (0<x<3) is preferably SiOx (1<x≤2). Note that the material of the transparent layer 40 may be an organic material such as PMMA (acrylic resin), PVA (polyvinyl alcohol), polysilazane, or polystyrene.

Further, the transparent layer 40 may be formed of a plurality of layers. In this case, the materials of the plurality of layers may be the same as each other, or may be different from each other.

The refractive index of the transparent layer 40 may be different from, or may be the same as, the refractive index of the dielectric layer 20. When the refractive index of the transparent layer 40 is the same as the refractive index of the dielectric layer 20, a Rayleigh anomaly described later is apt to be generated. Further, when the dielectric layer 20 is omitted, the refractive index of the transparent layer 40 may be higher, or may be lower, than the refractive index of the substrate 10, but the difference therebetween is preferably set to no more than 0.20. When the refractive index difference is within this range, the influence of the refractive index difference is suppressed, and the Rayleigh anomaly described later is likely to occur regardless of the incident direction of the light. As a result, the SLR described later is apt to be induced. Note that when the refractive index difference is out of the range described above, when, for example, the light is incident from the substrate 10 side, Fresnel reflection is likely to occur on an interface between the substrate 10 and the transparent layer 40. As a result, there is a possibility that the optical energy making a contribution to the generation of the plasmon resonance described later decreases to decrease the enhanced electric field.

The transparent layer 40 has the upper surface 42. The upper surface 42 is, for example, an interface between the transparent layer 40 and an air layer. Further, the upper surface 42 is a surface on which the target substance to be detected is disposed.

The upper surface 42 shown in FIG. 1 has the concavo-convex structure 44. By providing such a concavo-convex structure 44, the refractive index in a direction straddling the upper surface 42 (a direction of the normal line Q) gradually changes along the normal line Q. Therefore, for example, when the light is incident from the substrate 10 side in FIG. 1, the incident light is transmitted through the substrate 10 and the dielectric layer 20 to reach the microstructures 30. Further, a part of the light reaches the upper surface 42 and seeps above the upper surface 42 due to the influence of the gentle refractive index gradient. Accordingly, the enhanced electric field above the upper surface 42 can be strengthened. Further, for example, when the light is incident from the transparent layer 40 side in FIG. 1, the incident light is transmitted through the transparent layer 40 to reach the microstructures 30. Further, a part of the light is reflected by the substrate 10 and returns to the upper surface 42. Also in this case, the part of the light seeps above the upper surface 42 due to the influence of the gentle refractive index gradient. In this way, the enhanced electric field at a position above the upper surface 42 can further be strengthened.

Further, the concavo-convex structure 44 may have a function of holding the target substance disposed on the upper surface 42. Accordingly, the target substance can be stably disposed, and a decrease in detection sensitivity can be suppressed. Note that the concavo-convex structure 44 will be described later in detail.

### 1.2. Enhanced Electric Field

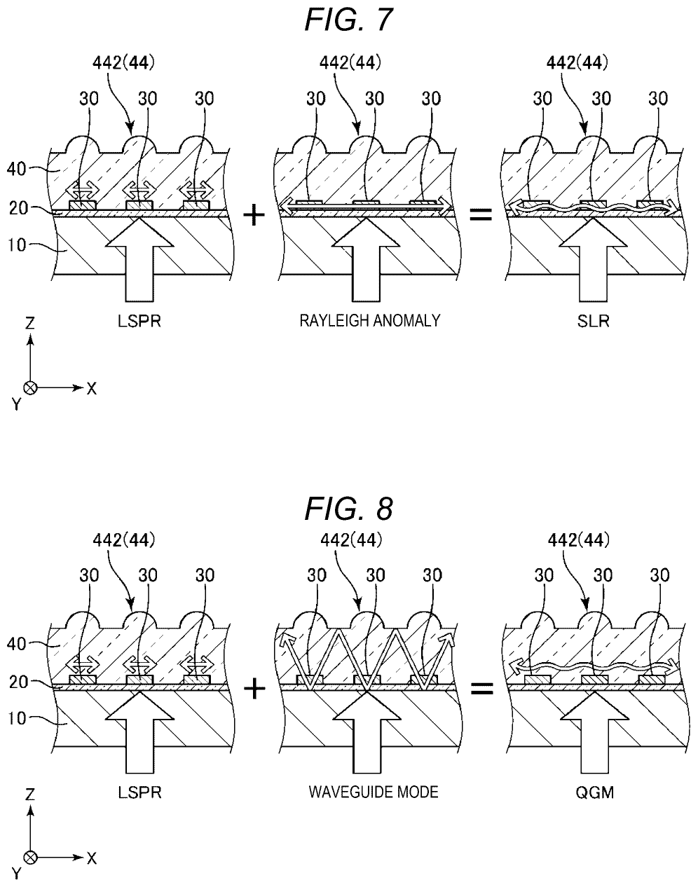

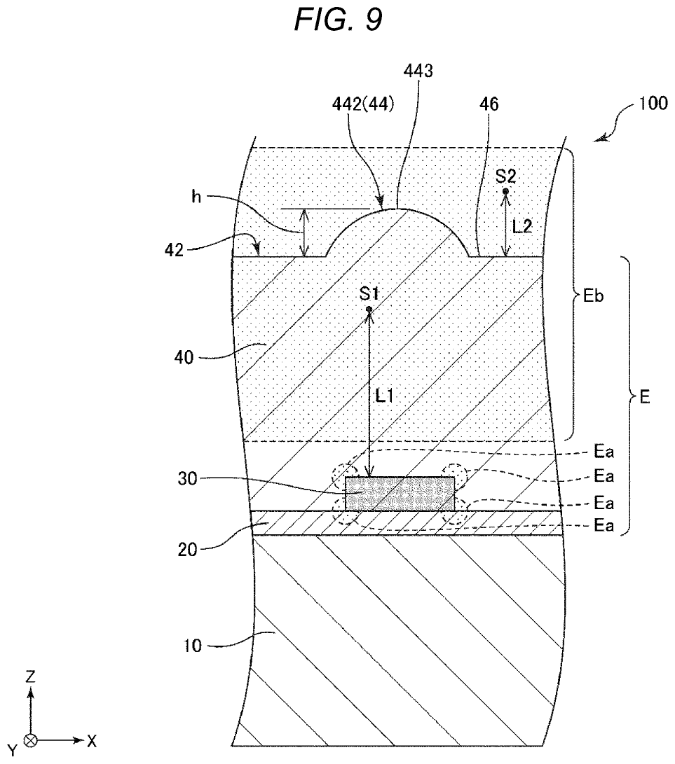

FIGS. 7 and 8 are conceptual diagrams illustrating the plasmon resonance in the electric field enhancement device 100. FIG. 9 is a diagram illustrating an enhanced electric field E generated by the microstructure 30 of the electric field enhancement device 100.

In the example illustrated in FIGS. 7 and 8, the light incident from the substrate 10 side reaches the plurality of microstructures 30. The light that has reached the microstructure 30 causes the plurality of microstructures 30 to generate the plasmon resonance. The wavelength of the light is, for example, no less than 350 nm and no more than 850 nm. When the wavelength of light is within the range described above, the plasmon resonance is easily generated in the microstructure 30.

As shown in FIG. 7, when the light reaches the microstructure 30, the LSPR described above is induced. In addition, 90°-diffraction by the plurality of microstructures 30, that is, Rayleigh anomaly occurs. When the Rayleigh anomaly and the LSPR are combined, the surface lattice resonance (SLR) is induced.

Further, as shown in FIG. 8, the incident light is guided through the transparent layer 40. By combining the waveguide mode in the transparent layer 40 and the LSPR, a quasi-guided mode (QGM) is induced.

Then, the SLR and the resonance state such as QGM are combined and cooperate, and cooperative plasmon polaritons are induced in the plurality of microstructures 30. As illustrated in FIG. 9, the enhanced electric field E generated by the plurality of microstructures 30 due to the combination of the SLR and the resonance state such as the QGM includes not only first enhanced fields Ea generated at ends of the microstructures 30 due to the LSPR but also a second field above enhanced Eb generated the microstructures 30 due to the SLR and the resonance state such as the QGM.

The enhanced electric field E enhances the Raman scattered light and generates the SERS. The enhanced electric field E is maximized by the second enhanced field Eb at a position S1 or a position S2 (the position S1 or the position S2 located at an opposite side of the plurality of microstructures 30 to the substrate 10 in the Z-axis direction and separated from the plurality of microstructures 30) separated upward from the plurality of microstructures 30. It can be said to be a feature of the phenomenon of the cooperative plasmon polariton that the enhanced electric field E is maximized at the position S1 or the position S2. The position S1 and the position S2 shown in FIG. 9 are located at the Z axis plus side of the plurality of microstructures 30.

In the electric field enhancement device 100 illustrated in FIG. 9, the upper surface 42 of the transparent layer 40 has the concavo-convex structure 44. Since such a concavo-convex structure 44 is provided, the refractive index does not discontinuously change between the transparent layer 40 and the air layer, but a pseudo gradient occurs in the refractive index. Accordingly, the light incident on the transparent layer 40 seeps upward from the upper surface 42. Therefore, in the electric field enhancement device 100, since the concavo-convex structure 44 is provided, the enhanced electric field located above the upper surface 42 can further be strengthened.

According to such a configuration, the detection sensitivity of the electric field enhancement device 100 can be improved. For example, when the enhanced electric field E is generated only at the end of the microstructure 30 due to the LSPR, the effect that the enhanced electric field E is generated cannot be obtained unless the target substance is located in the vicinity of the microstructure 30. In general, since the probability that the target substance is located in the vicinity of the microstructure varies, the detection sensitivity is likely to decrease when the enhanced electric field is generated only at the end of the microstructure. In addition, the reproducibility of the detection also decreases. Further, when the size of the target substance is large, the target substance cannot enter an area between the microstructures adjacent to each other, and it may be difficult to locate the target substance near the microstructure in some cases.

In contrast, in the electric field enhancement device 100 illustrated in FIG. 9, the enhanced electric field E generated by the plurality of microstructures 30 is maximized at the position S1 or the position S2 (the position S1 or the position S2 separated from the plurality of microstructures 30 located at the opposite side of the plurality of microstructures 30 to the substrate 10 in the Z-axis direction) separated upward from the plurality of microstructures 30 in the normal direction. Therefore, the detection signal caused by the target substance can be enhanced without locating the target substance in the vicinity of the microstructure 30. As a result, the detection sensitivity can be improved. In addition, since it is not necessary to locate the target substance between the microstructures 30 adjacent to each other, samples in various sizes such as viruses and bacteria can be freely selected as the target substances.

Further, in the electric field enhancement device 100, since the position S1 or the position S2 of the local maximum point is separated from the vicinity of the microstructure 30, it is possible to provide the transparent layer 40 that covers the microstructure 30. That is, even when the transparent layer 40 is provided, it is possible to apply the enhanced electric field E to the target substance to enhance the detection signal caused by the target substance. Therefore, unintended chemical changes such as oxidation and sulfurization of the microstructure 30 can be suppressed. In particular, Ag is likely to be altered or deformed by oxidation, sulfurization, migration, or the like. In the electric field enhancement device 100, even when Ag is used as the microstructure 30, such alteration and deformation can be suppressed. As a result, the durability and reliability of the electric field enhancement device 100 can be improved.

Further, in the electric field enhancement device 100, since the transparent layer 40 has the concavo-convex structure 44, the enhanced electric field E can further be strengthened in particular above the upper surface 42. That is, the probability that the enhanced electric field E is maximized at the position S2 becomes high. Thus, the detection sensitivity can particularly be improved.

Further, by providing the concavo-convex structure 44, it becomes easy to hold the target substance disposed on the upper surface 42. Accordingly, the target substance can stably be disposed, and thus, a decrease in detection sensitivity can be suppressed.

Note that the second enhanced field Eb may be separated from the first enhanced field Ea as illustrated in FIG. 9, or may be continuous with the first enhanced field Ea.

Further, in FIG. 9, the local maximum point at which the enhanced electric field E is maximized is located at the position S1 or the position S2. Out of these, the position S1 shown in FIG. 9 is located in the transparent layer 40. In this case, in a normal direction to the upper surface 42, a distance L1 from the microstructure 30 to the position S1 may be less than 100 nm, but is preferably no less than 100 nm, and more preferably no less than 200 nm. Accordingly, since the enhanced electric field E generated above the upper surface 42 can also be strengthened, even when the target substance is not located in the vicinity of the microstructure 30, in other words, even when the target substance is disposed on the upper surface 42, the enhanced electric field E acts on the target substance, and the detection signal caused by the target substance can be enhanced.

Further, in FIG. 9, the enhanced electric field E reaches the t air layer across the upper surface 42. Further, the local maximum point of the enhanced electric field E may be located at the position S2 shown in FIG. 9. The position S2 shown in FIG. 9 is located in the air layer. That is, the enhanced electric field E may be maximized at a position separated from the transparent layer 40 in the normal direction to the upper surface 42. In this case, the detection signal caused by the target substance disposed on the upper surface 42 can be further enhanced.

Further, in this case, a distance L2 from the upper surface 42 (a surface of the transparent layer 40) to the position S2 (the local maximum point) may be no more than 100 nm, or may be more than 100 nm.

When the distance L2 is no more than 100 nm, the probability that the position S2 acts on the target substance disposed on the upper surface 42 is high as long as the size of the target substance is no more than 100 nm. Therefore, the detection signal caused by the target substance can be particularly enhanced.

When the distance L2 exceeds 100 nm, even when the size of the target substance exceeds 100 nm, the probability that the position S2 acts on the target substance disposed on the upper surface 42 is high. Therefore, even when target substances in various sizes are mixed, the detection signals caused by the target substances can be uniformly enhanced.

Note that the distance L2 is a separation distance in the normal direction between a lowermost point 46 the closest to the substrate 10 out of the upper surface 42 and the position S2. As shown in FIG. 9, the lowermost point 46 is defined as a point where the upper surface 42 lowers to the lowest position when viewing a cross-section of a repeating unit including any one of the microstructures 30. The cross-section shown in FIG. 9 can be acquired by, for example, observing, with an electron microscope, a cut surface obtained by cutting the electric field enhancement device 100 so as to include the normal line Q.

### 1.3. Concavo-Convex Structure

The concavo-convex structure 44 may be shifted from the microstructure 30 when viewed from the normal direction to the substrate 10, but is preferably disposed at a position overlapping the microstructure 30 as shown in FIG. 1. In this case, since the enhanced electric field distribution in which the enhanced electric field is distributed from the microstructure 30 and the position of the concavo-convex structure 44 are aligned, the strength of the enhanced electric field E formed above the upper surface 42 can be homogenized. Accordingly, the detection signal caused by the target substance can uniformly be enhanced.

Note that the expression “the concavo-convex structure 44 and the microstructure 30 overlap each other” refers to a state in which an area occupied by the concavo-convex structure 44 and an area occupied by the microstructure 30 at least partially overlap each other when viewed from the normal direction.

The height h of the concavo-convex structure 44 shown in FIG. 9 is preferably no less than 1 nm and no more than 500 nm, more preferably no less than 1 nm and no more than 200 nm, and still more preferably no less than 1 nm and no more than 40 nm. When the height h of the concavo-convex structure 44 is within the range described above, the gradient of the refractive index across the upper surface 42 can be optimized. Therefore, the enhanced electric field E formed above the upper surface 42 can particularly be strengthened.

Note that as illustrated in FIG. 9, the height h is calculated from a length in the normal direction between the lowermost point 46 the closest to the substrate 10 and the uppermost point 443 the farthest from the substrate 10 in the repeating unit including any one of the concavo-convex structures 44. Specifically, the lengths are measured in 10 or more repeating units, and an average value thereof is defined as the “height h”.

The shape of the concavo-convex structures 44 is not particularly limited, but may be a shape having a plurality of convex portions 442 protruding upward as illustrated in FIG. 1, or may be a shape having a plurality of concave portions recessed downward although not illustrated.

Further, the convex portion 442 shown in FIG. 1 has a hemispherical shape. Accordingly, the pseudo gradient of the refractive index formed between the transparent layer 40 and the air layer becomes gentler. Therefore, the enhanced electric field E formed above the upper surface 42 can further be strengthened. Note that the hemispherical shape means a convex curved surface protruding upward. The convex curved surface may be a true spherical surface or an aspherical surface.

When the convex portion 442 has the hemispherical shape, the curvature radius of the convex portion 442 is preferably no more than 125 μm, more preferably no less than 1 μm and no more than 100 μm, and still more preferably no less than 3 μm and no more than 50 μm. According to such a configuration, it becomes easy to optimize the pitch between the convex portions 442 and the height h of the convex portion 442. Therefore, when the convex portions 442 are disposed at positions overlapping the microstructures 30, the independence between the convex portions 442 is ensured to make it easy to control the shape of the concavo-convex structure 44, and the manufacturing difficulty of the concavo-convex structure 44 can be reduced.

FIG. 10 is a top view schematically showing the electric field enhancement device 100 according to the embodiment.

In the electric field enhancement device 100 shown in FIG. 10, a plurality of convex portions 442 is arranged along a plane (X-Y plane) in which the substrate 10 spreads. Thus, the gradient of the refractive index can be formed uniformly along the X-Y plane. Therefore, the enhanced electric field E can be strengthened in a wide range of the upper surface 42.

In the example shown in FIG. 10, the microstructures 30 (not shown) are arranged in a square lattice shape, and the convex portions 442 are also arranged in a square lattice shape, accordingly. The arrangement pattern of the convex portions 442 is not limited thereto. For example, the convex portions 442 may be arranged in a triangular lattice shape similarly to the microstructures 30 illustrated in FIG. 3, or may be arranged in another arrangement pattern.

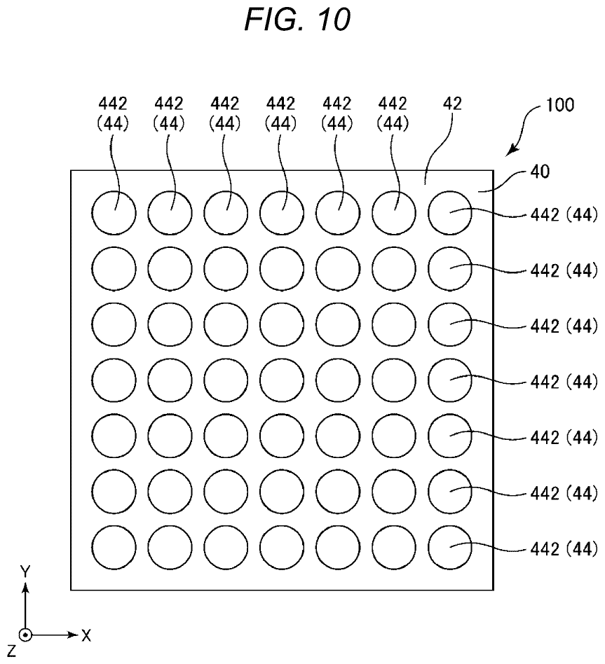

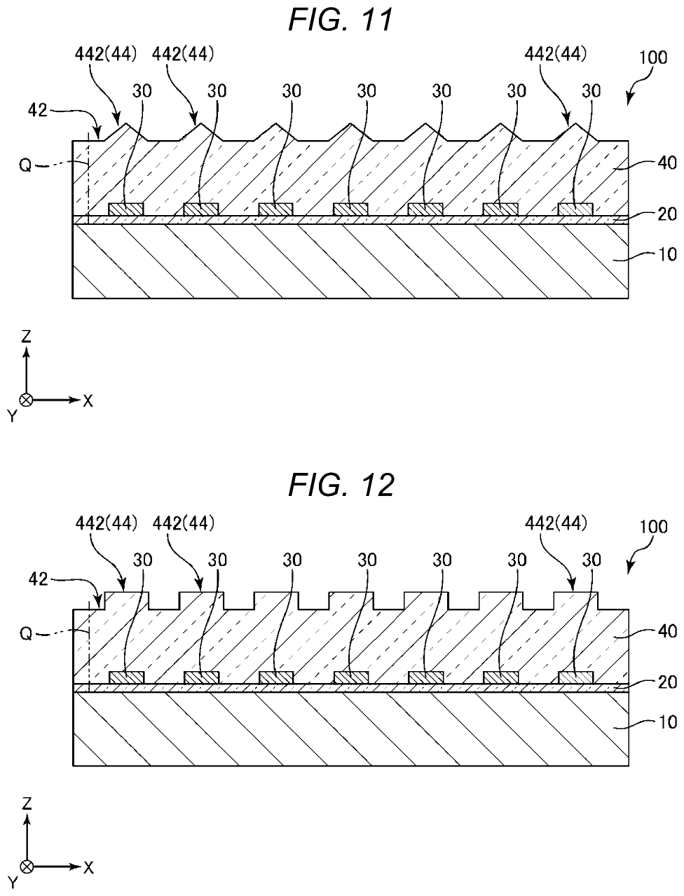

FIGS. 11 to 13 are each a cross-sectional view schematically showing the electric field enhancement device 100 according to the embodiment. The cross-sectional shape of the convex portion 442 is not limited to the hemispherical shape shown in FIG. 1, and may be another shape as shown in FIGS. 11 to 13.

The concavo-convex structure 44 illustrated in FIG. 11 has the convex portion 442 having a triangular cross-sectional shape. When the convex portion 442 illustrated in FIG. 11 is viewed from the normal direction to the substrate 10, the planar shape of the convex portion 442 is, for example, a circular shape. In this case, the convex portion 442 shown in FIG. 11 has a conical shape. Accordingly, since a gap between the convex portions 442 is widened, it becomes easy for the target substance to enter the gap. Further, the pseudo gradient of the refractive index formed between the transparent layer 40 and the air layer becomes gentler. Note that the convex portion 442 illustrated in FIG. 11 may have a pyramid shape.

The concavo-convex structure 44 illustrated in FIG. 12 has the convex portion 442 having a rectangular cross-sectional shape. When the convex portion 442 illustrated in FIG. 12 is viewed from the normal direction to the substrate 10, the planar shape of the convex portion 442 is, for example, a circular shape or a quadrangular shape. In this case, the convex portion 442 shown in FIG. 12 has a cylindrical shape or a quadrangular prism shape. Accordingly, it becomes easy for the target substance to enter the gap between the convex portions 442. Note that the convex portion 442 illustrated in FIG. 12 may have a prismatic shape other than the quadrangular prism shape.

Further, the planar shape of the convex portion 442 may be a shape other than the above, for example, an annular shape or a linear shape.

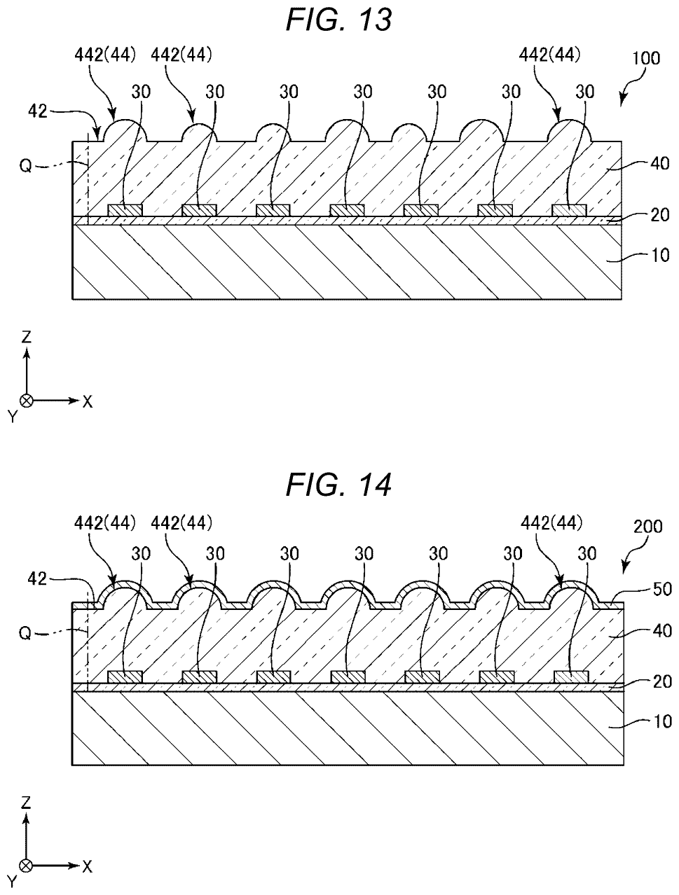

In the concavo-convex structures 44 illustrated in FIG. 13, the height h and the arrangement pattern of the convex portions 442 are random. The term “random” means that the height h is different between the convex portions 442 adjacent to each other, or the pitch between the convex portions 442 is different between at least two locations. Such a concavo-convex structure 44 makes a contribution to a reduction in the manufacturing difficulty of the electric field enhancement device 100.

The diameter of the convex portion 442 is not particularly limited, but is preferably no less than 1 nm and no more than 1000 nm, more preferably no less than 5 nm and no more than 500 nm, and still more preferably no less than 10 nm and no more than 400 nm.

When the planar shape (the shape when viewed on the Z axis) of the convex portion 442 is a circle, the diameter of the convex portion 442 is a diameter of the circle, and when the planar shape of the convex portion 442 is not a circle, the diameter of the convex portion 442 is a diameter of a minimum inclusion circle.

The pitch of the convex portions 442 is not particularly limited, but is preferably no less than 20 nm and no more than 1000 nm, and more preferably no less than 100 nm and no more than 900 nm.

The pitch of the convex portions 442 means a distance between the centers of the convex portions 442 adjacent to each other. When the planar shape of the convex portion 442 is a circle, the center of the convex portion 442 is the center of the circle, and when the planar shape of the convex portion 442 is not a circular shape, the center of the convex portion 442 is the center of the minimum inclusion circle.

### 2. Method of Manufacturing Electric Field Enhancement Device

Then, an example of a method of manufacturing the electric field enhancement device 100 will be described.

First, the dielectric layer 20 is formed on the substrate 10. The dielectric layer 20 is formed by, for example, a vapor deposition method, a sputtering method, a chemical vapor deposition (CVD) method, or an atomic layer deposition (ALD) method.

Then, the plurality of microstructures 30 is formed on the dielectric layer 20. The microstructures 30 are formed by forming a thin film using, for example, a vacuum deposition method or a sputtering method, and then patterning the thin film. Examples of the patterning method include electron beam (EB) lithography, photolithography and etching, a microcontact printing method, and a nanoimprint method.

Then, the transparent layer 40 is formed on the dielectric layer 20 and the microstructures 30. Accordingly, the electric field enhancement device 100 can be obtained. The transparent layer 40 is formed by, for example, a vapor deposition method, a sputtering method, a CVD method, an ALD method, or a sol-gel method.

In addition, by adjusting the thickness of the transparent layer 40 or the deposition rate in accordance with the thickness, the pitch, and so on of the microstructures 30, it is possible to form the concavo-convex structures 44 aligned with the positions of the microstructures 30. For example, the height h of the convex portions 442 can be increased by increasing the thickness of the microstructures 30 or increasing the pitch therebetween.

Meanwhile, by using electron beam (EB) lithography, photolithography and etching, a microcontact printing method, a nanoimprint method, a mask deposition method, a lift-off method, or the like, the convex portions 442 satisfying any shapes, arrangement patterns, heights h, pitches, and so on can be formed.

### 3. Modified Examples of Electric Field Enhancement Device

Then, electric field enhancement devices according to modified examples of the embodiment will be described.

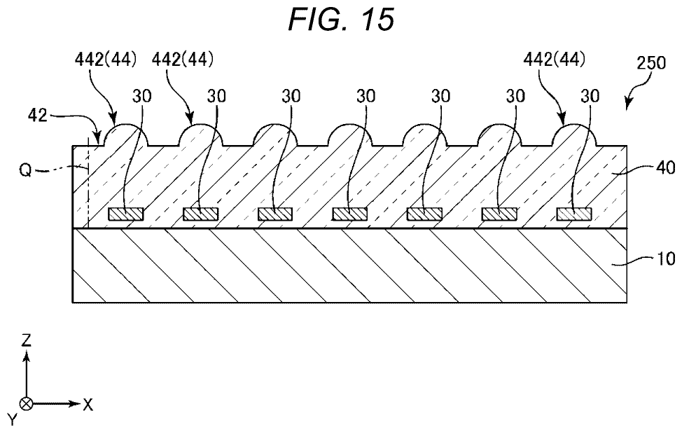

FIG. 14 is a cross-sectional view schematically illustrating n electric field enhancement device 200 according to a first modified example of the embodiment. FIG. 15 is a cross-sectional view schematically illustrating an electric field enhancement device 250 according to a second modified example of the embodiment.

The electric field enhancement device 200 according to the first modified example of the embodiment will hereinafter be described with a focus on differences from the electric field enhancement device 100 described above, and the description of substantially the same configuration will be omitted. Note that in FIGS. 14 and 15, substantially the same configurations as those of the electric field enhancement device 100 described above are denoted by the same reference symbols.

The electric field enhancement device 200 shown in FIG. 14 is substantially the same as the electric field enhancement device 100 except that a molecular trapping layer 50 is provided.

The molecular trapping layer 50 is disposed on the transparent layer 40 so as to be in contact with the transparent layer 40. The molecular trapping layer 50 is an organic molecular film, and is, for example, a self-assembled monolayer (SAM).

The thickness of the molecular trapping layer 50 is not particularly limited, but is preferably no less than 0.1 nm and no more than 1 nm, and more preferably no more than 0.4 nm.

The thickness of the molecular trapping layer 50 is measured from an observation image obtained by observing a cross-section of the molecular trapping layer 50 with an electron microscope. In the observation image, the length in the Z-axis direction of the molecular trapping layer 50 is measured at 10 or more points randomly extracted, and an average value thereof is defined as the “thickness”.

The molecular trapping layer 50 has a function of trapping the target substance. The molecular trapping layer 50 is appropriately selected depending on the type of the target substance, and examples thereof include an alkanethiol film and a silane coupling agent. The molecular trapping layer 50 is formed by, for example, a dipping method, a vacuum deposition method, a molecular vapor deposition (MVD) method, or a CVD method.

In the electric field enhancement device 200, since the molecular trapping layer 50 is disposed on the transparent layer 40, deposition unevenness of the molecular trapping layer 50 can be alleviated. For example, when the transparent layer is not provided and the molecular trapping layer is directly deposited on the microstructures and the substrate, the physical and chemical states are different between the surfaces of the microstructures and the surface of the substrate, and thus the deposition unevenness of the molecular trapping layer may occur in some cases.

In addition, in the electric field enhancement device 200, as described above, since the target substance is not required to be located in the vicinity of the microstructure 30, the selectivity of the molecular chain length in the molecular trapping layer 50 increases. Note that although not illustrated, a primer layer for improving adhesion between the transparent layer 40 and the molecular trapping layer 50 may be disposed therebetween.

The electric field enhancement device 250 shown in FIG. 15 is substantially the same as the electric field enhancement device 100 except that the transparent layer 40 is extended instead of the dielectric layer 20 shown in FIG. 1. That is, the transparent layer 40 shown in FIG. 15 is also extended to the region where the dielectric layer 20 shown in FIG. 1 extends. Thus, there is provided a state in which the microstructures 30 are surrounded by the transparent layer 40 in the cross-section shown in FIG. 15.

In such a modified example as described above, substantially the same advantages as those of the embodiment described above can be obtained.

### 4. Raman Spectroscopic Apparatus

Then, a Raman spectroscopic apparatus according to the embodiment will be described.

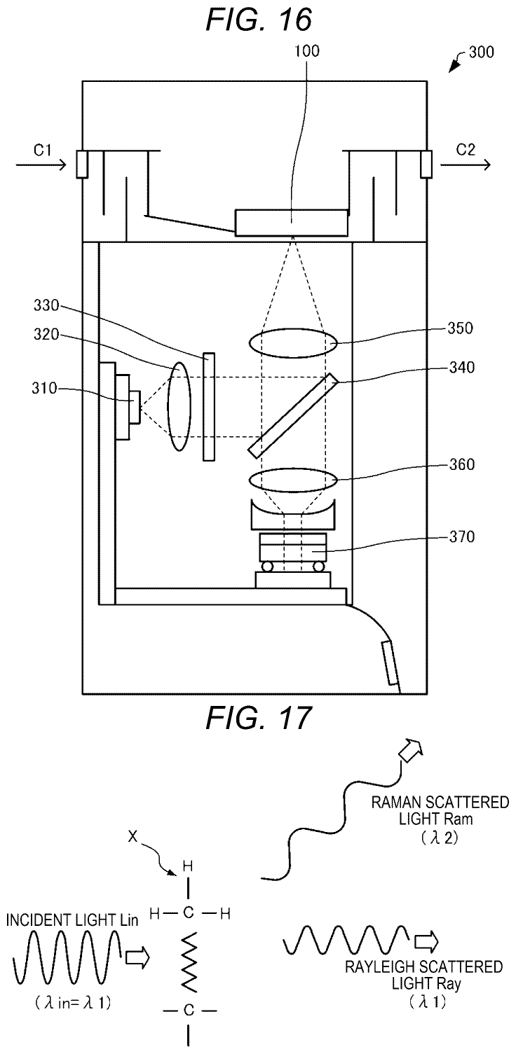

FIG. 16 is a diagram schematically showing a Raman spectroscopic apparatus 300 according to the embodiment.

### 4.1. Configuration

The Raman spectroscopic apparatus 300 shown in FIG. 16 includes the electric field enhancement device 100, a light source 310, a collimator lens 320, a polarization control element 330, a dichroic mirror 340, an objective lens 350, a condenser lens 360, and a detector 370. Note that for the sake of convenience of illustration, the electric field enhancement device 100 is simplified in FIG. 16.

The target substance is carried into the Raman spectroscopic apparatus 300 from a C1 direction and is then carried out in a C2 direction. For example, by driving a fan (not shown), the target substance is introduced from the carry-in port into a substance transport unit and is then discharged from a discharge port to the outside of the substance transport unit.

The light source 310 irradiates the electric field enhancement device 100 with the light. The light emitted from the light source 310 has a wavelength that induces resonance such as SLR and QGM in the electric field enhancement device 100. Examples of the light source 310 include a laser and a light emitting diode (LED). Examples of the laser include a vertical cavity surface emitting laser (VCSEL) and a photonic crystal surface emitting laser (PCSEL).

The light emitted from the light source 310 is, for example, collimated by the collimator lens 320, transmitted through the polarization control element 330, and guided toward the electric field enhancement device 100 by the dichroic mirror 340. The light traveling toward the electric field enhancement device 100 is condensed by the objective lens 350 and is incident on the electric field enhancement device 100. On this occasion, the target substance is in contact with the transparent layer 40 of the electric field enhancement device 100.

When the light is incident on the electric field enhancement device 100, the enhanced electric field E is generated by the plurality of microstructures 30. When the target substance is located in the enhanced electric field E, the SERS light is generated therefrom. The SERS light is transmitted through the objective lens 350, then transmitted through the dichroic mirror 340 to be guided toward the detector 370. The SERS light traveling toward the detector 370 is condensed by the condenser lens 360 and then enters the detector 370.

The detector 370 detects the SERS light emitted from the electric field enhancement device 100. The detector 370 is, for example, a diffraction grating spectrometer. Then, in the Raman spectroscopic apparatus 300, the detector 370 performs spectral decomposition on the SERS light to obtain spectral information. Note that the detector 370 may be a Fabry-Perot etalon spectrometer.

### 4.2. Principle

FIG. 17 is a diagram illustrating the principle of the Raman scattering spectroscopy.

In FIG. 17, the target substance X is irradiated with the incident light Lin having a wavelength λin. Then, scattered light is emitted from the target substance X. The scattered light includes, besides the Rayleigh scattered light Ray having the same wavelength λ1 as the wavelength Ain of the incident light Lin, the Raman scattered light Ram having a wavelength λ2 different from the wavelength λ1. An energy difference between the Raman scattered light Ram and the incident light Lin corresponds to the energy of an oscillation level, a rotation level, and an electron level of the target substance X. Since the target substance X has specific vibration energy according to the structure of the target substance X, the target substance X can be identified from the Raman scattered light Ram by using the incident light Lin having the wavelength Xin.

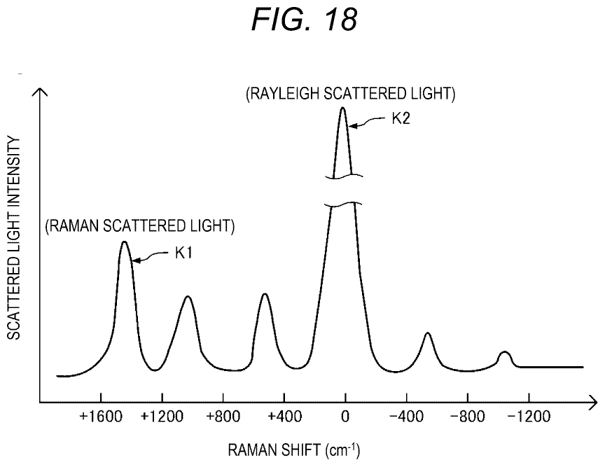

FIG. 18 is a schematic diagram illustrating an example of a Raman spectrum acquired by the Raman scattering spectroscopy. In FIG. 18, the horizontal axis represents a Raman shift. The Raman shift is a difference between the wave number (frequency) of the Raman scattered light Ram and the wave number of the incident light Lin, and has a value specific to the molecular bonding state of the target substance X.

When comparing the scattered light intensity K1 of the Raman scattered light Ram and the scattered light intensity K2 of the Rayleigh scattered light Ray illustrated in FIG. 18 with each other, it is understood that the scattered light intensity K1 of the Raman scattered light Ram is weaker. As described above, the Raman scattering spectroscopy is excellent in ability to identify the target substance X, but has a problem that the sensitivity to detect the target substance X is low. Therefore, in the Raman spectroscopic apparatus 300, the SERS is used to achieve high sensitivity.

### 5. Advantages Provided by Embodiment

The electric field enhancement device according to the embodiment includes the substrate 10, the plurality of microstructures 30, and the transparent layer 40. The microstructures 30 are disposed on the substrate 10 and have electrical conductivity. The transparent layer 40 covers the plurality of microstructures 30 and the substrate 10. The transparent layer 40 has the concavo-convex structures 44 on the upper surface 42 (the opposite surface to the microstructures 30). Further, the enhanced electric field E generated by the plurality of microstructures 30 is maximized at a position at the opposite side of the plurality of microstructures 30 to the substrate 10 in the normal direction to the substrate 10 and separated from the plurality of microstructures 30.

According to such a configuration, the detection signal caused by the target substance can be enhanced without locating the target substance in the vicinity of the microstructures 30. As a result, the electric field enhancement device capable of improving the detection sensitivity can be obtained. In addition, since it is not necessary to locate the target substance between the microstructures 30 adjacent to each other, various samples such as viruses and bacteria can be freely selected as the target substances. Further, since the transparent layer 40 has the concavo-convex structure 44, the enhanced electric field E can further be strengthened in particular above the upper surface 42. Thus, the detection sensitivity can particularly be improved.

In the electric field enhancement device according to the embodiment described above, it is preferable that the concavo-convex structure 44 is disposed at a position overlapping the microstructure described above when viewed from the normal direction to the substrate 10.

According to such a configuration, since the enhanced electric field distribution in which the enhanced electric field is distributed from the microstructure 30 and the position of the concavo-convex structure 44 are aligned, the strength of the enhanced electric field E formed above the upper surface 42 can be homogenized. Accordingly, the detection signal caused by the target substance can uniformly be enhanced.

In the electric field enhancement device according to the embodiment described above, the height h of the concavo-convex structure 44 is preferably no less than 1 nm and no more than 500 nm.

According to such a configuration, the gradient of the refractive index across the upper surface 42 (the surface at the opposite side to the microstructures 30) can be optimized. Therefore, the enhanced electric field E formed above the upper surface 42 can particularly be strengthened.

In the electric field enhancement device according to the embodiment described above, the concavo-convex structures 44 may have the plurality of convex portions 442 arranged along the plane in which the substrate 10 spreads, and the convex portion 442 may have a hemispherical shape.

According to such a configuration, the pseudo gradient of the refractive index formed between the transparent layer 40 and the air layer becomes gentler. Therefore, the enhanced electric field E formed above the upper surface 42 can further be strengthened.

In the electric field enhancement device according to the embodiment described above, the curvature radius of the convex portion 442 is preferably no more than 125 μm.

According to such a configuration, it becomes easy to optimize the pitch between the convex portions 442 and the height h of the convex portion 442. Therefore, when the convex portions 442 are disposed at positions overlapping the microstructures 30, the independence between the convex portions 442 is ensured to make it easy to control the shape of the concavo-convex structure 44, and the manufacturing difficulty of the concavo-convex structure 44 can be reduced.

In the electric c field enhancement device according to the embodiment described above, the concavo-convex structures 44 may have the plurality of convex portions 442 arranged along the plane in which the substrate 10 spreads, and the convex portion 442 may have a conical shape.

According to such a configuration, since a gap between the convex portions 442 is widened, it becomes easy for the target substance to enter the gap. Further, the pseudo gradient of the refractive index formed between the transparent layer 40 and the air layer becomes gentler.

In the electric field enhancement device according to the embodiment described above, the concavo-convex structures 44 may have the plurality of convex portions 442 arranged along the plane in which the substrate 10 spreads, and the cross-sectional shape of the convex portion 442 cut along the plane including the normal line Q to the substrate 10 may be a rectangular shape.

According to such a configuration, it becomes easy for the target substance to enter the gap between the convex portions 442.

In the electric field enhancement device according to the embodiment described above, when the position S1 at which the enhanced electric field E is maximized is defined as the local maximum point, the distance L1 from the microstructure 30 to the position S1 (the local maximum point) in the normal direction to the substrate 10 may be 100 nm or more.

According to such a configuration, even when the target substance is disposed on the upper surface 42, the enhanced electric field E acts on the target substance, and the detection signal caused by the target substance can be enhanced.

In the electric field enhancement device according to the embodiment, the enhanced electric field E may be maximized at the position S2 separated from the transparent layer 40 in the normal direction to the substrate 10.

According to such a configuration, the detection signal caused by the target substance disposed at the opposite side of the plurality of microstructures 30 to the substrate 10 (on the upper surface 42) can further be enhanced.

In the electric field enhancement device according to the embodiment described above, it is preferable for the microstructures 30 to be periodically arranged.

According to such a configuration, it is possible to reduce a variation in the intensity of the enhanced electric field E in the in-plane direction. In addition, since the microstructures 30 are periodically arranged, the SLR is easily induced.

In the electric field enhancement device according to the embodiment described above, the material of the microstructures 30 is preferably metal.

According to such a configuration, the enhanced electric field can further be strengthened.

The Raman spectroscopic apparatus according to the embodiment described above includes the electric field enhancement device according to the embodiment described above, the light source 310, and the detector 370. The light source 310 irradiates the electric field enhancement device with the light. The detector 370 detects the light from the electric field enhancement device.

According to such a configuration, the Raman spectroscopic apparatus 300 capable of improving the detection sensitivity can be obtained.

Although the electric field enhancement device and the Raman spectroscopic apparatus according to the present disclosure have been described based on the preferred embodiment illustrated in the drawings, the present disclosure is not limited to the embodiment and the modified examples. For example, the configuration of each unit in the embodiment and the modified examples described above may be replaced with any configuration having substantially the same function, or may be added with any other configuration. Further, what is obtained by combining two or more of the embodiments and the modified examples described above may be adopted.

### Practical Examples

Then, specific examples of the present disclosure will be described.

### 6. Experimental Example A

### 6.1. Practical Example 1

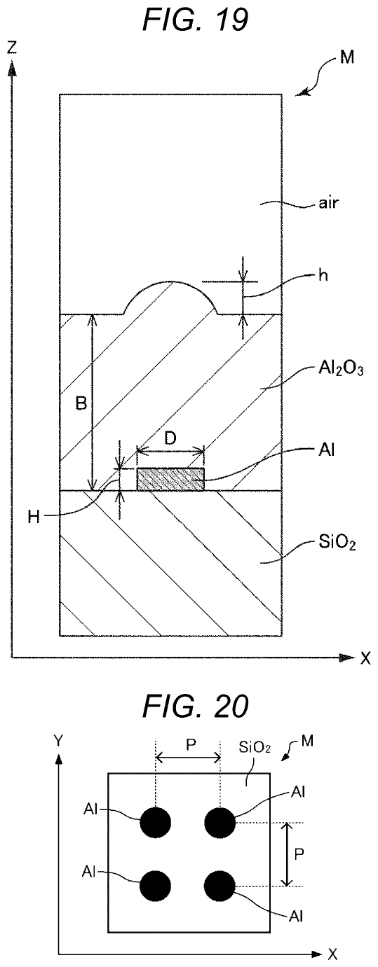

FIG. 19 is an X-Z cross-sectional view schematically illustrating a repeating unit of a model M used in a simulation. FIG. 20 is an X-Y cross-sectional view schematically illustrating the model M used in the simulation.

In the model M, as shown in FIG. 19, the material of the substrate was quartz glass (SiO₂), and the material of a reflective layer was Al₂O₃. In addition, the thickness B of the transparent layer was 360 nm, the material of the microstructures was Al, the diameter D of the microstructure was 156 nm, and the thickness H of the microstructure was 60 nm. In addition, in the model M, as illustrated in FIG. 20, the array of the microstructures was in a square lattice shape, the shape of the microstructure was a cylinder, and the pitch P of the microstructures was 391 nm. Further, an air layer “air” was formed above the transparent layer. Further, the height h of the concavo-convex structure (convex portion) was set to 50 nm, the shape of the convex portion was a hemispherical shape having a diameter of 156 nm, and the convex portion was disposed immediately above the microstructure.

Then, light was incident from the substrate side of the model M shown in FIG. 19, and the intensity distribution of the enhanced electric field was calculated. The wavelength of the incident light was 476 nm.

### 6.2. Reference Example 1

In Reference Example 1, in the model M described above, the height h of the concavo-convex structure was zero, that is, the concavo-convex structure was omitted. Further, the thickness B of the transparent layer was 275 nm, the diameter D of the microstructure was 260 nm, the thickness H of the microstructure was 140 nm, the pitch of the microstructures was 434 nm, and the wavelength of the incident light was 434 nm. The intensity distribution of the enhanced electric field was calculated in substantially the same condition as in Practical Example 1 except these.

### 6.3. Comparative Example 1

In Comparative Example 1, the intensity distribution of the enhanced electric field was calculated in substantially the same manner as in Practical Example 1 except that the thickness B of the transparent layer was zero, that is, the transparent layer was not provided, the material of the microstructures was Ag, the diameter D of the microstructure was 50 nm, the thickness H of the microstructure was 25 nm, the pitch P of the microstructures was 250 nm, and the wavelength of the incident light was 464 nm.

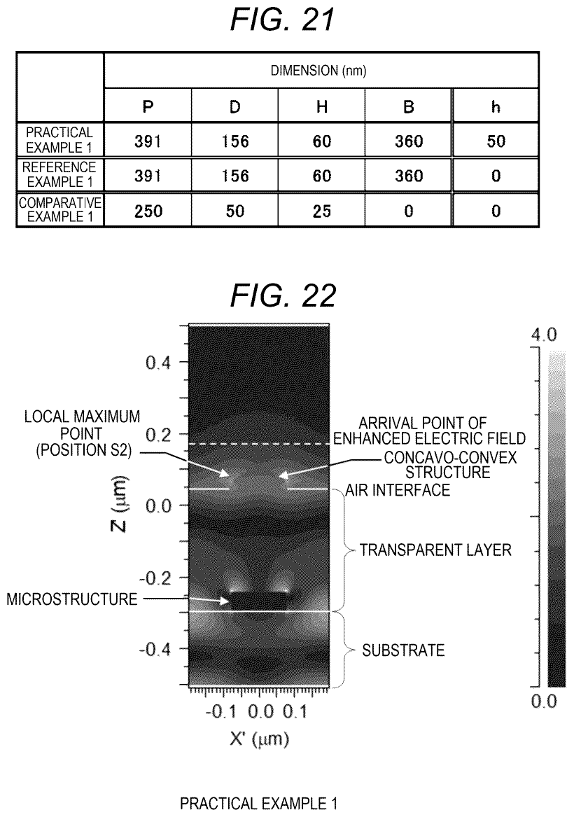

FIG. 21 is a table showing a comparison of principal parameters in Practical Example 1, Reference Example 1, and Comparative Example 1.

### 7. Result of Experimental Example A

In each of the models of Practical Example 1, Reference Example 1, and Comparative Example 1 as described above, a simulation for estimating the distribution of the enhanced electric field was performed. A finite difference time domain (FDTD) method was used for the simulation. As simulation software, RSoft manufactured by Synopsys, Inc. was used.

FIGS. 22 to 24 are simulation results of Practical Example 1, Reference Example 1, and Comparative Example 1 in Experimental Example A, respectively. FIGS. 22 to 24 each show a normalized distribution of the enhanced electric field in the X-Z cross-section.

Shading in FIGS. 22 to 24 represents the intensity of the enhanced electric field in the X-Z cross-section. Specifically, when the X component of the enhanced electric field is represented by Ex and the Z component of the enhanced electric field is represented by Ez, a square root of (Ex²+Ez²), that is, √(Ex²+Ez²) is reflected in the shading in FIGS. 22 to 24.

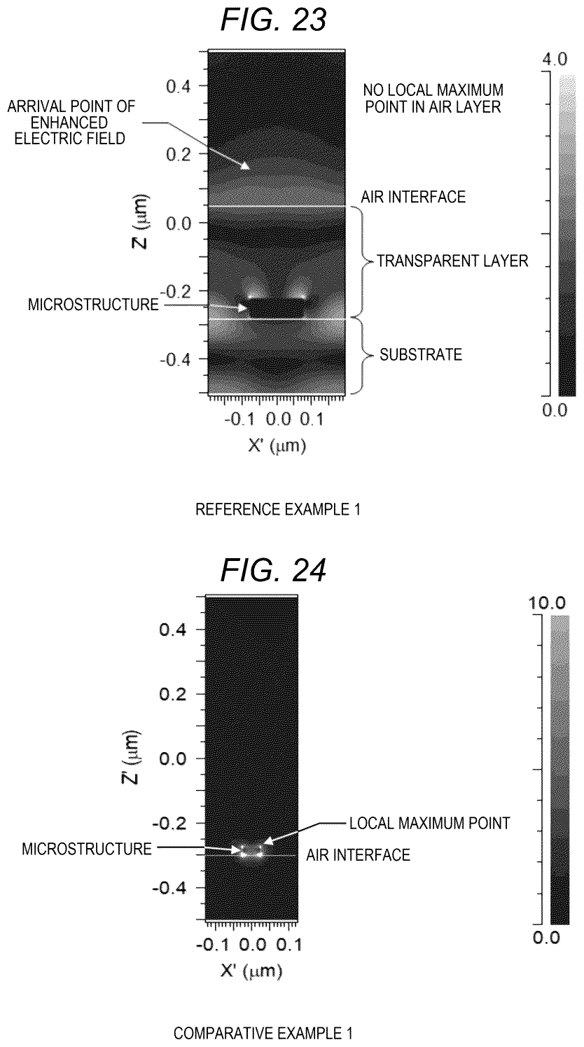

In FIGS. 22 and 23, the “AIR INTERFACE” represents an interface between the transparent layer and the air layer. In FIG. 24, the “AIR INTERFACE” represents the interface between the substrate and the air layer.

In FIG. 22, the enhanced electric field is maximized at the position S2 sufficiently separated upward (at the air layer side) from the air interface. In addition, a clearer local maximum point compared to FIG. 23 occurs at the position S2, and it is understood that the enhanced electric field is sufficiently strong. Further, the distance from the air interface to the position S2 of the local maximum point shown in FIG. 22 is no more than 100 nm. Further, the enhanced electric field shown in FIG. 22 reaches a position at a distance no less than 100 nm from the air interface in the air layer.

Further, in FIG. 24, no enhanced electric field was observed at a position away from the microstructure.

From the above result, it was confirmed that it was possible to realize the electric field enhancement device in which the enhanced electric field is maximized at the position S2 sufficiently distant from the transparent layer.

### 8. Experimental Example B

### 8.1. Practical Example 2

In Practical Example 2, a model which is substantially the same as the model of Practical Example 1 except that the shape of the convex portion is a conical shape having a diameter of 156 nm was prepared.

### 8.2. Practical Example 3

In Practical Example 3, a model which is substantially the same as the model of Practical Example 1 except that the shape of the convex portion is a quadrangular prism having a square bottom, 156 nm on a side, was prepared.

### 8.3. Reference Example 2

In Reference Example 2, a model which is substantially the same as the model of Practical Example 1 except that the concavo-convex structure is omitted was prepared.

### 9. Result of Experimental Example B

In each of the models of Practical Examples 1 to 3 and Reference Example 2 as described above, the simulation s performed on the distribution of the enhanced electric field. A finite difference time domain (FDTD) method was used for the simulation. As simulation software, RSoft manufactured by Synopsys, Inc. was used.

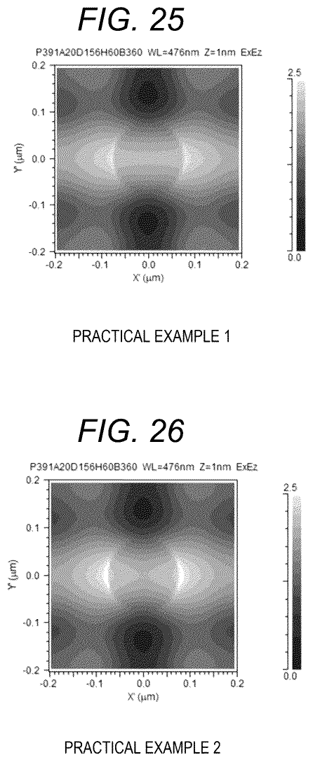

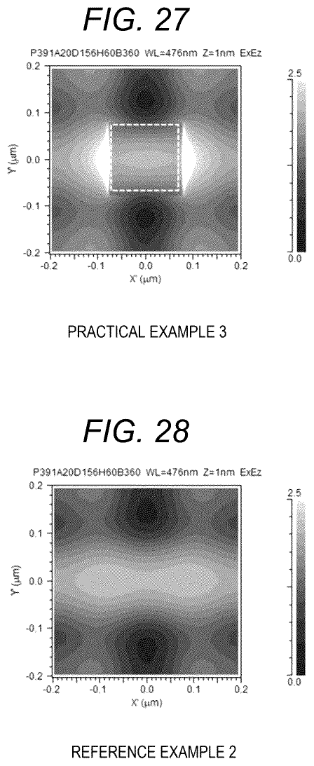

FIGS. 25 to 28 show simulation results of Practical Examples 1 to 3 and Reference Example 2 in Experimental Example B, respectively. FIGS. 25 to 28 each show a normalized distribution of the enhanced electric field in the X-Y plane at a position at a distance of 1 nm upward from the center of the concavo-convex structure.

Shading in FIGS. 25 to 28 represents the intensity of the enhanced electric field in the X-Y plane. Specifically, when the X component of the enhanced electric field is represented by Ex and the Y component of the enhanced electric field is represented by Ey, a square root of (Ex²+Ey²), that is, √(Ex²+Ey²) is reflected in the shading in FIGS. 25 to 28.

As shown in FIGS. 25 to 28, in Practical Examples 1 to 3 in which the concavo-convex structure is provided, the enhanced electric field formed in the air layer is strengthened compared to Reference Example 2 in which the concavo-convex structure is not provided.

From the above results, it was confirmed that the enhanced electric field formed in the air layer was further strengthened by providing the concavo-convex structure in the transparent layer.

What is claimed is:

1. An electric field enhancement device comprising:
a substrate;
a plurality of microstructures provided to the substrate and having electrical conductivity; and
a transparent layer configured to cover the plurality of microstructures and the substrate, wherein
the transparent layer has a concavo-convex structure on a surface at an opposite side to the microstructures, and
an enhanced electric field generated by the plurality of microstructures is maximized at a position at an opposite side of the microstructures to the substrate in a normal direction to the substrate and separated from the plurality of microstructures.

2. The electric field enhancement device according to claim 1, wherein
the concavo-convex structure is disposed at a position overlapping the microstructure when viewed from the normal direction.

3. The electric field enhancement device according to claim 1, wherein
a height of the concavo-convex structure is no less than 1 nm and no more than 500 nm.

4. The electric field enhancement device according to claim 1, wherein
the concavo-convex structure includes a plurality of convex portions arranged along a plane in which the substrate spreads, and
the convex portion has a hemispherical shape.

5. The electric field enhancement device according to claim 4, wherein
a curvature radius of the convex portion is no more than 125 μm.

6. The electric field enhancement device according to claim 1, wherein
the concavo-convex structure includes a plurality of convex portions arranged along a plane in which the substrate spreads, and
the convex portion has a conical shape.

7. The electric field enhancement device according to claim 1, wherein
the concavo-convex structure includes a plurality of convex portions arranged along a plane in which the substrate spreads, and
a cross-sectional shape of the convex portion cut along a plane including a normal line to the substrate is a rectangular shape.

8. The electric field enhancement device according to claim 1, wherein
when defining a position where the enhanced electric field is maximized as a local maximum point,
a distance from the microstructure to the local maximum point in the normal direction is no less than 100 nm.

9. The electric field enhancement device according to claim 1, wherein
the enhanced electric field is maximized at a position separated from the transparent layer in the normal direction.

10. The electric field enhancement device according to claim 1, wherein
the microstructures are periodically arranged.

11. The electric field enhancement device according to claim 1, wherein
the microstructures is composed of metal.

12. A Raman spectroscopic apparatus comprising:
the electric field enhancement device according to claim 1;
a light source configured to irradiate the electric field enhancement device with light; and
a detector configured to detect light from the electric field enhancement device.

13. A Raman spectroscopic apparatus comprising:
the electric field enhancement device according to claim 2;
a light source configured to irradiate the electric field enhancement device with light; and
a detector configured to detect light from the electric field enhancement device.
